(19) United States
(12) Patent Application Publication
(10) Pub. No.: US 2016/0278400 A1
(43) Pub. Date: Sep. 29, 2016

(54) PROCESS OF PREPARING CARAMEL COLOR REPLACEMENT

(71) Applicant: NONGSHIM CO.,LTD, Seoul (KR)

(72) Inventors: Jeong-Joo KIM, Incheon (KR); Moon-Hyuck CHOI, Seoul (KR); Soo-Hyun PARK, Seongnam-si (KR); Sung-Ug JUNG, Seoul (KR); Byoung-Oon JEON, Suwon-si (KR); Joo-Won PARK, Seoul (KR)

(21) Appl. No.: 14/964,497

(22) Filed: Dec. 9, 2015

(30) Foreign Application Priority Data
Mar. 27, 2015 (KR) 10-2015-0043063

(51) Int. Cl. A23G 3/32

(52) U.S. Cl. CPC A23G 3/32

(57) ABSTRACT

The present invention relates to a process of preparing a caramel color based food dye having the same or greater color intensity compared to that of a conventional caramel dye, and a caramel color based food dye using the process. The process uses Maillard reaction, not caramel reaction, to prepare a caramel color based food dye. It is possible to prepare a caramel color based food dye that does not generate harmful substances such as 4-MEI and has a similar color intensity and a color pattern as the conventionally used type-III caramel dye. Moreover, it is possible to avoid a harmful problem caused by the conventional type III caramel dye since the food dye of the present invention can be replaced with the conventional type III caramel dyes in the same amount.

### CROSS REFERENCE TO RELATED APPLICATIONS

The present application claims the priority benefit of Korean Patent Application No. 10-2015-0043063 filed in the Republic of Korea on Mar. 27, 2015, which is hereby incorporated by reference for all purposes as if fully set forth herein.

### BACKGROUND OF THE INVENTION

1. Field of the Invention

The invention relates to a process of preparing a caramel dye replacement, and more specifically, to a process of preparing a caramel based food dye having the same or greater color value as a conventional caramel dye without generating hazardous substance such as 4-methylimidazole (4-MEI).

2. Discussion of the Related Art

A caramel color dye is a most generally used food dye and prepared by caramelization from saccharides. The caramel color dye is produced as a resulting product of caramelization, which is a thermal decomposition reaction of the saccharides. In case of preparing the caramel color dye, various catalytic agents such as acids, alkaline compounds, ammonium compounds and sulfurous acids are used in order to increase color intensity of the caramel dye. The ammonium compounds among the catalytic agents have the most relevant effect on the color intensity of the caramel color dye.

The caramel color dye has been widely used in the whole food industries. Especially, type-III and type-IV caramel color dyes, which exhibit high color intensities, have been much widely used in terms of absolute quantities and prepared using ammonium compounds as catalytic agents. It has been reported that type-III and the type-IV caramel color dyes generate 4-methylimidazole (4-MEI), which has been known as a potential carcinogen, owing to a reaction between hydrolyzed saccharides and ammonium compounds. As 4-MEI contained in the caramel color dyes has become a social issue, much researches have been developed to decrease the content of 4-MEI in the caramel color dyes.

For example, it is known to reduce the amount of 4-MEI by adding metal ions to the reactant in the course of preparing caramel dyes. Also, a process of preparing a caramel dye with a reduced content of 4-MEI comprises preparing a reactor accommodating one or more water-soluble carbohydrate solution selected from a saccharide solution, a starch hydrolyte solution, or a syrup in an internal part of the reactor, supplying ammonium compound-containing solution into the reactor through a top space over the reactor containing the water-soluble carbohydrate solution, and treating the water-soluble carbohydrate in the reactor in the present of the ammonium-compound. But, it is only possible to reduce the content of 4-MEI, but are not possible to prevent the production of 4-MEI in the course of preparing caramel dyes in the conventional processes.

On the other hand, 4-MEI is not generated in the course of preparing type-I and type-II caramel dyes because they are produced without using ammonium for enhancing color intensity. But, such caramel dyes exhibit lower color intensity, i.e. 20-30% compared to that of type-III and type-IV caramel dyes, therefore, type-I and type-II dyes have been limited in replacing the type-III and type-IV caramel dyes. In addition, type-I caramel color dyes or sugar syrups, which are brown based color dyes having similar color index as the type-III caramel dye, has been used in place of the type-III caramel dye. But, because such dyes exhibit lower color intensity, there is a need to increase the amount of the type-I caramel color dye or the sugar syrup 3-4 times as that of the type-III caramel dye in order to implement the same color intensity as the type-III caramel dye. Accordingly, in case of using the type-I caramel dye or the sugar syrup, there are problems of increasing the amount of the dyes, and thereby causing the expense to prepare the final product to raise and resulting in increased bitter tastes in the final product. Further, since the type-I caramel dye and/or the sugar syrup have more reddish color pattern compared to the type-III caramel dye, color changes in the final products resulted from the color pattern differences among the food dyes in spite of masking the bitter taste and adjusting the same color intensity as the type-III caramel dye.

### SUMMARY OF THE INVENTION

Accordingly, the present invention is directed to a process of preparing caramel color based food dye and the caramel color based food dye that substantially obviate one or more of the problems due to limitations and disadvantages of the related art.

An advantage of one of more embodiments of the present invention is to provide a process of preparing a caramel color based food dye by excluding the ammonium catalytic agents so as to inhibit basically and substantially the generation of 4-MEI, and a caramel color based food dye without containing 4-MEI.

Another object of the present invention is to provide a process of preparing a caramel color based food dye having the same or greater color intensity as the conventional type-III and type-IV caramel dyes by optimizing the reaction conditions, and a caramel color based food dye which may be prepared by the process.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

In accordance with an embodiment of the present invention, as embodied and broadly described herein, a process of preparing a caramel color based food dye may comprise treating thermally a mixture of a saccharide and an amino acid admixed with a weight ratio of about 1:0.1 to about 1:1.2 at a temperature within a range of about 40° C. to about 90° C.; adjusting an acidity of the thermally treated mixture to have a pH within a range of about 6 to about 9; and performing a Maillard reaction with the acidity adjusted mixture.

The saccharide may be selected from the group consisting of glucose, fructose, galactose, xylose, sucrose, a vegetable extract or a vegetable sap and combination thereof.

The vegetable extract may be selected from the group consisting of an onion extract, a radish extract, a Korean cabbage extract, a garlic extract, a cabbage extract, a carrot extract and combination thereof.

In one exemplary embodiment, the saccharide may comprise a monosaccharide such as glucose, fructose, galactose and/or xylose.

For example, the monosaccharide may comprise a pentose such as xylose.

For example, the amino acid may comprise a hydrophobic amino acid which may be selected from the group consisting of such as glycine, alanine and combination thereof.

In an illustrative embodiment of the present invention, the step of wherein adjusting an acidity of the thermally treated mixture comprises adding an alkaline compound to the thermally treated mixture.

The alkaline compound may be selected from the group consisting of sodium carbonate, potassium carbonate, tri-sodium phosphate, tri-potassium phosphate, sodium acetate, sodium hydroxide, calcium hydroxide and combination thereof.

The Maillard reaction may be performed at a temperature within a range of about 100° C. to about 140° C. and a pressure within a range of about 0.9 to about 1.5 bar for about 0.5 to about 5 hours.

In an exemplary embodiment, the process may further comprise drying a product obtained by the Maillard reaction.

The step of drying is performed by means selected from the group consisting of a vacuum drying, a hot air drying, a spray drying, a freeze drying and combination thereof.

In another aspect, the present invention provides a caramel color based food dye having a color intensity of about 200 to about 500 and a hue index of about 4 to about 6, wherein the food dye contains melanoidine and does not contain 4-methylimidazole (4-MEI).

In one embodiment, the food dye may be prepared by the process of the present invention.

It is to be understood that both the foregoing general description and the following detailed description are exemplary and explanatory and are intended to provide further explanation of the invention as claimed.

### DETAILED DESCRIPTION OF THE ILLUSTRATED EMBODIMENTS

Advantages and features of the present invention and methods of accomplishing the same may be understood more readily by reference to the following detailed description of exemplary embodiments. However, the present invention will be embodied in many different forms and is not limited to the embodiments set forth herein. Rather, these embodiments are provided to complete the disclosure of the present invention and to completely convey the concept of the invention to one of skill in the art, and the present invention will be defined only by a category of claims.

Shapes, sizes, rates, angles, numbers, etc. as disclosed in the drawings for explaining the embodiments of the present invention are illustrative and are not limited to the details shown. The same reference numerals throughout the specification refer to the same elements. Additionally, in the following description of the present invention, a detailed description of the well-known technique that is determined to unnecessarily obscure the subject matter of the present invention will be omitted.

In cases that “include”, “have”, “comprise”, etc. are mentioned on this specification, other parts may be added unless “only” is used together. The term of the component used in the singular without specific mention includes plural ones.

Interpretation of the component includes a margin of error even if there is no clear description.

When the description of the positional relationship between two parts includes ‘on’, ‘over’, ‘under’, ‘beside’, etc., one or more parts may be positioned between the two parts unless “right” or “direct” is used.

When the description of the time sequential relation includes ‘after’, ‘followed by, ‘next’, ‘before’, etc., non-continuous cases may be included unless right” or “direct” is used.

The first, second, etc. may be used to describe these various components, but these components are not limited by these terms. These terms are only used to distinguish one element to the other components. Thus, the first component referred to below may be a second component within the scope of the present invention.

Characteristics of the various embodiments of the present invention may be partially or fully coupled to or combined with each other and may be technically variously linked and driven, and each of the embodiments may be performed independently with respect to each other and be carried together in relation with each other.

Hereinafter, embodiments of the present invention will be described in detail with reference to accompanying drawings.

The process of preparing of caramel color based food dye in accordance one aspect of the present invention may comprise treating thermally a mixture of a saccharide and an amino acid admixed with a weight ratio of about 1:0.1 to about 1:1.2 at a temperature within a range of about 40° C. to about 90° C.; adjusting an acidity of the thermally treated mixture to have a pH within a range of about 6 to about 9; and performing a Maillard reaction with the acidity adjusted mixture; and optionally drying a product obtained by the Maillard reaction.

In a process of preparing a caramel color based food dye in accordance with the present invention, the caramel color based food dye contains melanoidine which is produced by the Maillard reaction. The Maillard reaction is a representative non-enzymatic browning reaction and the most important reaction in a food industry. As the Maillard reaction is an interaction between reducing sugar and an amino group of an amino acid, brownish final product, melanoidine as well as various flavoring components as reaction products is produced through the Maillard reaction which is known as saccharide-amino reaction.

Melanoidine is very stable molecule and has an anti-oxidant function. The melanoidine causes almost whole foods such as a fermented food (for example, a soybean paste, a soy sauce, and the likes) or roasted coffee to be browning. It takes a long time to induce browning by a Maillard reaction in common conditions. Also, components resulted from the browning by the reaction is not appropriated for a food dye because the components do not show enough color intensity. However, in case of adjusting reaction conditions according to the present invention, it is possible to obtain a caramel color based food dye that contains melanoidine and exhibit high and color intensity, and that can be used for a caramel color dye in the food industry.

In the process of preparing a caramel color based food dye in accordance with the present invention, a first step is a step of treating thermally a mixture of a saccharide and an amino acid admixed with a weight ratio of about 1:0.1 to about 1:1.2 at a temperature within a range of about 40° C. to about 90° C., preferably about 60° C. to about 80° C. and thereby dissolving the saccharide as a liquid state in purified water. With treating thermally the mixture within the above-mentioned temperature ranges, it is possible to dissolve the saccharide as a powder phase with ease, and to prepare the mixture of the saccharide and the amino acid that can induce a Maillard reaction in a pH adjusting step.

For example, the saccharide contained in the mixture may comprise, but are not limited to, a group consisting of glucose, fructose, galactose, xylose, sucrose, a vegetable extract or sap and combination thereof. In one exemplary embodiment, a monosaccharide such as glucose, fructose, galactose, xylose and combination thereof may be used as the saccharide. In case of using the monosaccharide as the saccharide, it is possible to obtain high color value such as color intensity and/or hue index in the final food dye considering the cost price of the saccharide. Meanwhile, the vegetable extract or sap may be selected, but are not limited to, from the group consisting of an onion extract, a radish extract, a Korean cabbage extract, a garlic extract, a cabbage extract, a carrot extract and combination thereof.

Conventional caramel color food dye may be prepared by heating the saccharide and the catalytic agents such as ammonia at a high temperature. On the other hand, as the present invention uses Millard reaction as a main reaction for preparing the caramel color based food dye, the saccharide is mixed with an amino acid instead of the catalytic agents. The finally prepared caramel color based food dye may have different color values such as color intensity depending upon a mixture ration between the saccharide and the amino acid. In case of using a pentose such as xylose rather than a hexose such as glucose and/or fructose as the saccharide, it is possible to obtain higher color values in spite of reacting the same amount. However, proper saccharides other than the pentose may be selected considering the saccharide cost.

The amino acid mixed with the saccharide may comprise, but are not limited to, a hydrophobic amino acid. In one embodiment, the amino acid may be a hydrophobic amino acid that can be selected from the group consisting of glycine, alanine and combination thereof. The simpler the molecular structure of the amino acid, the more inexpensive in unit cost. Accordingly, an amino acid with simpler molecular structure such as glycine may be used.

In an exemplary embodiment, the saccharide and the amino acid may be mixed with a weight ratio of about 1:0.01 to about 1:1.2, preferably about 1:0.2 to about 1:1, more preferably about 1:05 to about 1:1. If the weight ratio of the saccharide and the amino acid is less than about 1:0.1, the finally prepared caramel color based food dye may show very low color values so that it may not replace the conventionally used caramel food dye. On the other hand, if the weight ratio of the saccharide and the amino acid is more than about 1:1.2, which deviates an optimal weight ratio range, the color intensity of the final product may be low and the production cost may be raised. In case of admixing the saccharide and the amino acid with a weight ratio of about 1:0.01 to about 1:1.2, it is possible to obtain a color value in the final product similar to that of type-III caramel dye.

After thermally treating, the acidity of the thermally treated mixture of the saccharide and the amino acid is adjusted to have a pH within a range of about 6 to about 9, preferably about 7 to about 9. In one embodiment, the acidity of the mixture may be adjusted by inducing alkaline compound to the thermally treated mixture. When the acidity of the mixture which is a reactant in subjecting to the alkaline compound treatment and contains the saccharide is adjusted within the above-mentioned ranges, the reaction rate in the below-mentioned Maillard reaction may increase, a material temperature of the mixture after the Maillard reaction may increase owing to self exothermal reaction by the Maillard reaction without supplying the reaction system with additional energy, and may prepare the food dye having an enhanced color value.

In one exemplary embodiment, a proper alkaline compound can be added to the thermally treated mixture in order to adjust the acidity of the mixture of the saccharide and the amino acid. For example, the alkaline compound may comprise, but are not limited to, a group consisting of sodium carbonate, potassium carbonate, tri-sodium phosphate, tri-potassium phosphate, sodium acetate, sodium hydroxide, calcium hydroxide and combination thereof. In one exemplary embodiment, sodium carbonate, tri-sodium phosphate, sodium hydroxide, calcium hydroxide and combination thereof may be used as the alkaline compound.

After adjusting the acidity of the mixture, a Maillard reaction is performed to the mixture of saccharide and the amino acid with adjusted acidity. For example, it is possible to prepare or produce a caramel color based food dye by reacting the saccharide and the amino acid in a condition of high temperature and high pressure.

In one exemplary embodiment, the Maillard reaction may be performed at a temperature within a range of about 100° C. to about 140° C., preferably about 100° C. to about 120° C., a pressure within a range of about 0.9 to about 1.5 bar, preferably about 0.9 to about 1.2 bar for about 0.5 to about 5 hours. If the reaction temperature is less than about 100° C., the finally prepared product, caramel color based food dye, has very low color values. On the other hand, if the reaction temperature is more than 140° C., the viscosity of the reactant is extremely raised so that it may be difficult performing molding processes such as a pulverization process and a milling process.

Alternatively, the process of preparing the food dye in accordance with the present invention may further comprise drying a reaction product in order to obtain powdered final product. The drying step may use any process that can dry and mill or powder the reaction products. For example, the drying step may comprises, but are not limited to, a group consisting of a vacuum drying, a hot air drying, a spray drying, a freeze drying and combination thereof.

In another aspect of the present invention, the present invention relates to a caramel color based food dye having a color intensity of about 200 to about 500 and a hue index of about 4 to about 6 and contains melanoidine without 4-methylimidazole (4-MEI). Optionally, the caramel color based food dye may comprise melanoidine. Unlike the conventionally used caramel dye, the caramel color based food dye in accordance with the present invention does not contain 4-MEI which is known as a potential carcinogen. Also, the caramel color based food dye of the present invention has a color intensity of about 200 to about 500 and a hue index of about 4 to about 6, which are similar values of the conventionally used type-III and type-IV caramel dyes. In addition, since the caramel color based food dye does not exhibit different or dissimilar tastes such as a bitter taste, it can replace the conventionally used caramel dye. In one exemplary embodiment, the caramel color based food dye may be prepared, but are not limited to, by the process as described above, but are not limited to.

Any harmful or hazardous substances or molecules such as 4-MEI are not produced in the process of preparing the caramel color based food dye in accordance with the present invention. Also, it is possible to prepare the caramel color based food dye that have the same or greater color intensity and hue index as the type-III caramel dye.

Therefore, it is possible to replace the food dye prepared in accordance with the present invention with the type-III caramel dye using the same amount or quantity. In addition, it is possible to prepare the caramel color based food dye at a lower cost, and maintain equally the qualities of the final product because the food dye of the present invention has the similar color indices as those of the conventionally used type-III caramel dye.

Hereinafter, the present invention will be described in more detail in the examples. But, the present invention is not intended to the disclosure in the example below.

### EXAMPLE 1

### Preparation of Caramel Color Based Food Dye

200 kg of purified water was put into a reaction vessel, and then 20 kg of a liquid-state onion extract and 70 kg of glucose was put into the vessel. The vessel was heated with stiffing until the material temperature reaches to 70° C. In order to obtain a mixture of saccharides and an amino acid, 60 kg of powdered glycine, and 5 kg of xylose was added to the heated saccharides.

1.9 kg of sodium hydroxide was added to the mixture of the saccharides and the amino acid with string to dissolve the components completely and adjust the acidity of the mixture to have pH 8.2. When the material temperature reaches 97° C., the reaction vessel was closed and the internal pressure of the vessel was controlled below 1.1 bar using a pressure proportionally pressure control valve. When the internal pressure of the vessel was exceed 1.1 bar, a vapor in the vessel was discharged to maintain the pressure below 1.1 bar.

The material temperature of the mixture was maintained at 122° C., and a Maillard reaction was performed for 3 hours with maintaining the temperature and the pressure. After completing the Millard reaction, the internal pressure was returned to atmospheric pressure, and the reaction product was cooled and then released out of the vessel. The product was dried and powdered using a spray dryer at a blowing temperature 170° C. and a ventilation temperature 110° C. to obtain a final product, a caramel color based food dye.

### EXAMPLES 2-6

### Preparation of Caramel Color Based Food Dye

A caramel color based food dyes were prepared by repeating the procedure of Example 1 except mixing the saccharide, amino acid and sodium hydroxide in accordance with the composition ratio in Table 1 below.

TABLE 1

| | | | Sodium | | |
|---|---|---|---|---|---|
| | Saccharide | Glycine | hydroxide | | Saccharide:amino acid |
| Example | (kg) | (kg) | (kg) | pH | (weigh ratio) |
| 2 | 100 | 0 | 0.6 | 7.8 | 100:0 |
| 3 | 100 | 25 | 1.26 | 7.8 | 100:25 |
| 4 | 100 | 50 | 1.78 | 7.8 | 100:50 |
| 5 | 100 | 75 | 1.98 | 7.8 | 100:75 |
| 6 | 100 | 100 | 1.76 | 7.8 | 100:100 |

### EXAMPLES 7-11

### Preparation of Caramel Color Based Food Dye According to Weight Ratio of Saccharide and Amino Acid

A caramel color based food dyes were prepared by repeating the procedure of Example 1 except mixing the saccharide, amino acid and sodium hydroxide and using 50 kg of purified water in accordance with the composition ratio in Table 2 below.

TABLE 2

| | | Radish | | | Sodium | Saccharide:amino |
|---|---|---|---|---|---|---|
| | Saccharide | Extract | | Alanine | hydroxide | acid |
| Example | (kg) | (kg) | Xylose (kg) | (kg) | (kg) | (weigh ratio) |
| 7 | 120 | 8 | 6 | 17 | 9.1 | 100:13 |
| 8 | 110 | 8 | 6 | 25 | 9.1 | 100:25 |
| 9 | 92 | 8 | 8 | 42 | 9.1 | 100:40 |
| 10 | 100 | 8 | 6 | 34 | 9.1 | 100:30 |
| 11 | 84 | 8 | 6 | 50 | 9.1 | 100:50 |

### EXAMPLES 12-19

### Preparation of Caramel Color Based Food Dye According to pH of Mixture of Saccharide and Amino Acid

A caramel color based food dyes were prepared by repeating the procedure of Example 1 except using sodium hydroxide in accordance with the composition ratio in Table 3 below.

TABLE 3

| Example | Sodium hydroxide (kg) | pH |
|---|---|---|
| 12 | 0 | 5.5 |
| 13 | 0.36 | 6.0 |
| 14 | 0.68 | 6.5 |
| 15 | 0.98 | 7.0 |
| 16 | 1.34 | 7.5 |
| 17 | 1.76 | 8.0 |
| 18 | 2.2 | 9.0 |
| 19 | 2.8 | 9.5 |

### COMPARATIVE EXAMPLES 1-3

As a caramel dye, type-III caramel dye (Daesang Corporation, Republic of Korea; Comparative Example 1), type-I caramel dye (SAN SOON SENG FOOD INDUSTRIEDS; Comparative Example 2), sugar syrup (SUDZUCKER AG; Comparative Example 1) was prepared.

### EXPERIMENTAL EXAMPLE 1

### Assay of Color Intensity and Hue Index of Carmel Color Based Food Dye

The color intensity, the hue index and the contents of 4-MEI among the caramel color based food dye prepared in Example 1, and the dye prepared in Comparative Examples 1-3 was measured. The color intensity and the hue index (linear hue index) was measured to the food dyes obtained from Example 1 and Comparative Examples 1-3 by diluting the food dyes and measuring the absorbance of 1,000 times diluents of the food dyes at 510 nm and 610 nm using 10 mm cell with spectro-photometer. Color intensity and the hue index of the food dyes were calculated by the following Formula 1 and Formula 2.

[Formula 1]

Color Intensity=(OD₆₁₀×dilution rate)/contents of solid, wherein OD₆₁₀ means an absorbance value at 610 nm

[Formula 2]

Hue Index=10 log [OD510/OD 610], wherein each of OD₅₁₀ and OD₆₁₀ means an absorbance value at 510 nm and 610 nm, respectively.

Meanwhile, In order to measure the contents of 4-MEI in the food dyes prepared Example 1 and Comparative Example 1-3, 10 g of each sample was extracted with purified water, and each of the extracted sample was subjected to LC/MS assay (liquid chromatography-mass spectrometer) with Acclaim™ Trinity™ PI column (mobile phase: ammonium acetate buffer (pH 5.7)). The measurement results for the color intensity, the hue index and the contents of 4-MEI of the food dyes are shown in Table 4 below.

TABLE 4

| Example | Color Intensity | Hue index | Content of 4-MEI |
|---|---|---|---|
| 1 | 350 | 5.1 | 9 |
| Comparative Example 1 | 330 | 5.0 | 76 |
| Comparative Example 2 | 85 | 6.4 | 0 |
| Comparative Example 3 | 90 | 5.8 | 76 |

Referring to Table 4, the caramel color based food dye of Example 1 has the highest color intensity and shows a hue index similar to the color intensity of type-III caramel dye of Comparative Example 1. As the dye has more hue index, it indicates reddish brown; on the other hand, as the dye has less hue index, it indicates dark brown. Especially, we certified that the caramel color based food dye in Example 1 does not contain 4-MEI.

### EXPERIMENTAL EXAMPLE 2

### Assay of Color Intensity According to Weight Ratio of Saccharide and Amino Acid

We measured the color intensity to the caramel color based food dye prepared in Examples 2-6 by repeating the procedure in Comparative Example 1. Table 5 shows measurement results.

TABLE 5

| | Saccharide:Amino acid | |
|---|---|---|
| Example | (Weight Ratio) | Color intensity |
| 2 | 100:0 | 57.8 |
| 3 | 100:25 | 220.9 |
| 4 | 100:50 | 324.1 |
| 5 | 100:75 | 370.9 |
| 6 | 100:100 | 360.2 |

Referring to Table 5, the food dye prepared in accordance with the present invention shows different color intensities depending upon the weight ratios between the saccharides (glucose, xylose and onion extract) and the amino acid (glycine). Especially, the food dyes by mixing the amino acid with the saccharides with a weight ratio of 1:02 to 1:1.2, preferably 1:1, shows 7-8 times high color intensities compared to the food dyes using only the saccharides.

### EXPERIMENTAL EXAMPLE 3

### Assay of Color Intensity According to Weight Ratio of Saccharide and Amino Acid

We measured the color intensity to the caramel color based food dye prepared in Examples 7-11 by repeating the procedure in Comparative Example 1. Table 6 shows measurement results.

TABLE 6

| | Saccharide:Amino acid | |
|---|---|---|
| Example | (Weight Ratio) | Color intensity |
| 7 | 100:13 | 251 |
| 8 | 100:20 | 350 |
| 9 | 100:40 | 406 |
| 10 | 100:30 | 410 |
| 11 | 100:50 | 383 |

Referring to Table 6, in case the weight ratio of the saccharide and the amino acid is within a range of 1:02 to 1:05, the color intensities of the food dyes are increased. In particular, when the weight ratio of the saccharide and the amino acid is 1:0.3, the food dye shows maximal color intensity. Accordingly, we certified that the optimal mixture ratio between the saccharide and the amino acid can be changed depending upon the kinds of the saccharides and the amino acid, and it is possible to select optimal kinds of and weight ratio between the saccharides and the amino acids considering the desired color values and production costs of the food dyes.

### EXPERIMENTAL EXAMPLE 4

### Assay of Color Intensity According to Weight Ratio of Saccharide and Amino Acid

We measured the color intensity to the caramel color based food dye prepared in Examples 12-19 by repeating the procedure in Comparative Example 1. Table 7 shows measurement results.

TABLE 7

| Example | Sodium Hydroxide (kg) | pH | Color intensity |
|---|---|---|---|
| 12 | 0 | 5.5 | 192.0 |
| 13 | 0.36 | 6.0 | 276.4 |
| 14 | 0.68 | 6.5 | 304.3 |
| 15 | 0.98 | 7.0 | 327.2 |
| 16 | 1.34 | 7.5 | 342.4 |
| 17 | 1.76 | 8.0 | 350.1 |
| 18 | 2.2 | 8.5 | 374.5 |
| 19 | 2.8 | 9.0 | 340.9 |

Referring to Table 7, we certified that the food dyes by mixing the saccharide with glycine with a weight ratio of 100:60 and adjusting the acidity of the mixture to have a pH 6.0 to 9 using alkaline compound shows 1.4˜1.8 times enhanced color intensities compared the food dyes by adjusting the acidity of pH 5.5.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A process of preparing a caramel color based food dye, the process comprising:
treating thermally a mixture of a saccharide and an amino acid admixed with a weight ratio of about 1:0.1 to about 1:1.2 at a temperature within a range of about 40° C. to about 90° C.;
adjusting an acidity of the thermally treated mixture to have a pH within a range of about 6 to about 9; and
performing a Maillard reaction with the acidity adjusted mixture.

2. The process according to claim 1, wherein the saccharide is selected from the group consisting of glucose, fructose, galactose, xylose, sucrose, a vegetable extract and combination thereof.

3. The process according to claim 2, wherein the vegetable extract is selected from the group consisting of an onion extract, a radish extract, a Korean cabbage extract, a garlic extract, a cabbage extract, a carrot extract and combination thereof.

4. The process according to claim 1, wherein the saccharide comprises a monosaccharide.

5. The process according to claim 5, wherein the saccharide comprises a pentose.

6. The process according to claim 1, wherein the amino acid comprises a hydrophobic amino acid.

7. The process according to claim 1, wherein the amino acid is selected from the group consisting of glycine, alanine and combination thereof.

8. The process according to claim 1, wherein adjusting an acidity of the thermally treated mixture comprises adding an alkaline compound to the thermally treated mixture.

9. The process according to claim 8, wherein the alkaline compound is selected from the group consisting of sodium carbonate, potassium carbonate, tri-sodium phosphate, tri-potassium phosphate, sodium acetate, sodium hydroxide, calcium hydroxide and combination thereof.

10. The process according to claim 1, wherein the Maillard reaction is performed at a temperature within a range of about 100° C. to about 140° C. and a pressure within a range of about 0.9 to about 1.5 bar for about 0.5 to about 5 hours.

11. The process according to claim 1, further comprising drying a product obtained by the Maillard reaction.

12. The process according to claim 11, wherein drying is performed by means selected from the group consisting of a vacuum drying, a hot air drying, a spray drying, a freeze drying and combination thereof.

13. A caramel color based food dye having a color intensity of about 200 to about 500 and a hue index of about 4 to about 6, wherein the food dye contains melanoidine and does not contain 4-methylimidazole (4-MEI).

14. The caramel color based food dye according to claim 13, wherein the food dye is prepared by a process of claim 1.
